(19) United States
(12) Patent Application Publication
(10) Pub. No.: US 2015/0363834 A1
(43) Pub. Date: Dec. 17, 2015

(54) ELECTRONIC PLATFORM SYSTEM AND METHOD FOR TARGETED SOCIAL NETWORK

(71) Applicant: THOMAS HENRIK ZILLIACUS, SINGAPORE (SG)

(72) Inventor: THOMAS HENRIK ZILLIACUS, SINGAPORE (SG)

(21) Appl. No.: 14/739,173

(22) Filed: Jun. 15, 2015

(30) Foreign Application Priority Data
Jun. 17, 2014 (SG) 10201403329P

(51) Int. Cl. G06Q 30/02; G06Q 20/12; G06Q 50/00

(52) U.S. Cl. CPC G06Q 30/0269; G06Q 30/0261; G06Q 50/01; G06Q 20/12

(57) ABSTRACT

An electronic platform system for a targeted social network that is coupled to a data mining engine, comprises a store platform that displays selected electronic stores from a plurality of electronic stores, wherein the selected electronic stores is selected by the data mining engine according to the user and a user group of the user, and a payment platform that enables the user to purchase goods directly from the store platform.

### CROSS-REFERENCE TO RELATED APPLICATION

The instant application claims priority to Singapore Patent Application No. 10201403329P, filed Jun. 17, 2014, the entire specification of which is expressly incorporated herein by reference.

### FIELD OF THE INVENTION

The present invention relates to electronic platform system and method thereof.

### BACKGROUND OF THE INVENTION

Social networking websites have become something of a global phenomenon that almost every one that is connected to internet may have used a social networking website or is using a particular social networking website. The social networking websites provide an online avenue for their members (also called users of the social networking website) to communicate with other users (e.g., their friends). In addition to that, the social networking websites have also grown to allow its members to participate in multi-player games, or collect interesting information such as news related to a specific topic and display it to the member periodically, etc.

In recent times, social networking websites have added features that allow one to sell products, to advertise products and to survey a market for a respective product. The reason for social networking websites having become a choice among the seller/advertiser/marketers is the convenience of selling a product through online and perhaps a large number of potential buyers that are already available on these websites. For example, a seller wishing to sell a product through a social networking website may just upload a picture of the product and subsequently post to sell the product.

However, each social networking website is relatively general, i.e., it does not target any specific group or interest. For example, a social networking website may discuss sports, computer gadgets and other interests all in one place. A seller/advertiser/marketer may find it difficult whether to target such social networking websites for their respective product.

Furthermore, the social networking websites are open for any user within the world to join and promote. It prevents localization and in some ways hinders the growth of local industry player.

It is within this context that the embodiments described herein arise.

### SUMMARY OF THE INVENTION

Embodiment described herein includes an electronic platform system for a targeted social network and methods to operate the electronic platform system. It should be appreciated that the embodiments can be implemented in numerous ways, such as a process, an apparatus, a system, a device, or a method. Several embodiments are described below.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 shows an illustrative user device coupled to a network system in accordance with one embodiment of the present invention.

FIG. 2 shows an illustrative interaction that happens between a network server and a user device in accordance with one embodiment of the present invention.

FIG. 3 show illustrative webpages that are displayed on a user device when a user selects a particular button in accordance with one embodiment of the present invention.

FIG. 4 shows an illustrative flowchart of a method of navigating social networking system in accordance with one embodiment of the present invention.

FIG. 5 shows another illustrative flowchart for a method of navigating social networking system in accordance with one embodiment of the present invention.

FIG. 6 shows an illustrative e-commerce business model that is available through the social networking system in accordance with one embodiment of the present invention.

### DETAILED DESCRIPTION OF THE INVENTION

The following embodiments describe an electronic platform system for a targeted social network and methods to operate the electronic platform system. It will be obvious, to one skilled in the art, that the present exemplary embodiments may be practiced without some or all of these specific details. In other instances, well-known operations have not been described in detail in order not to unnecessarily obscure the present embodiments.

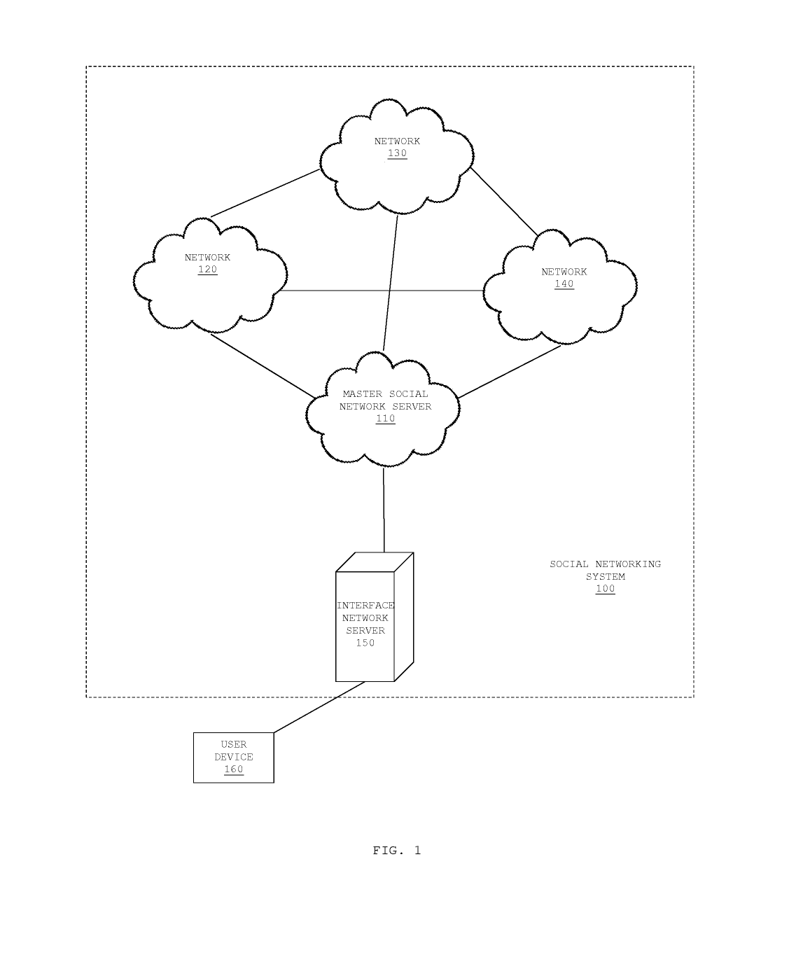

FIG. 1, meant to be illustrative and not limiting, illustrates a user device coupled to a network system in accordance with one embodiment of the present invention. User device 160 may be coupled to social networking system 100 that includes network server 150, master social network 110 and network clouds 120, 130 and 140. A user using user device 160 may enter master social network 110 through network server 150. Once hopping onto master social network 110, the user may navigate through the corresponding network clouds 120, 130 and 140 that are interlinked with master social network 110.

Referring still to FIG. 1, social networking system 100 is a platform whereby users may interact with objects and other users. Generally, social networking system 100 utilizes a web-based interface comprising a series of inter-connected webpages enabling the user to interact with objects within social networking system 100. For example, social networking system 100 may display a webpage for each user comprising objects and information entered by or related to the social networking system user (e.g., the user's “profile”). In one embodiment, social networking system 100 may further contain pages containing pictures or videos, dedicated to concepts, dedicated to users with similar interests (“groups”), or containing communications or social networking system activity to, from or by other users. Social networking system 100 may further include additional capabilities such as search, real-time communication, content-item uploading, purchasing, advertising, and any other web-based technology or ability.

It should be appreciated that social networking system 100 may provide an interface based on a web browser or a non-web browser application depending on user device 160. In one embodiment, social networking system 100 provides an interface page, for example, a web page, an application interface or display, a widget displayed over a web page or application, a box or other graphical interface, an overlay window on another page (whether within or outside the context of a social networking system), or a web page external to the social networking system with a social networking system plug in or integration capabilities.

A user may gain access to social networking system 100 through creating an account of social networking system 100. User's account may include the users profile, for example, biographic, demographic, and other types of descriptive information, such as work experience, educational history, hobbies or preferences, location, and the like. When creating the account for social networking system 100, a user may provide login information, such as a login email address or a login ID and a password. In one embodiment, the provided login information must be used by the user to sign into and access social networking system 100 for subsequent sessions between the user and social networking system 100. Upon the user creating the user account, the user may gain access to master social network 110 (through network server 150) and network clouds 120, 130 and 140.

As shown in the embodiment of FIG. 1, a user is coupled to network server 150 through user device 160. User device 160 may include configuration or functionality that allows the user to communicate via any network, or internet. User device 160 may be coupled to social networking system 100 through a choice of internet or available networks, which allows user device 160 to perform receipt and transmittal of data. In one embodiment, the medium in which user device 160 may be coupled to social networking system 100 may comprise any wired or wireless networks. In one embodiment, user device 160 may use an available operating system, for example, iOS, ANDROID, Microsoft Windows, Apple OS, of Linux based operating systems. Thus, user device 160 may be a personal digital assistant, a tablet, a smart phone, a laptop computing system, a net book, a desktop computer, or other device that integrate computing and data communication functionality. The user may then utilize a variety of applications on user device 160 to allow interaction with social networking system 100.

Referring still to FIG. 1, network sever 150 may be a gateway for user device 160 to master social network 110. In one embodiment, network server 150 may be a computer server that is capable of processing the users input (e.g., users request to perform transaction through network system 100). As stated in the above example, when a user wishes to interact with another user, the signals from the user is transmitted to the network server 150 and then to the master social network and subsequently to another user.

Master social network 110 is further coupled to network clouds 120, 130 and 140. The Master social network 110 provides users capability to explore and consume contents from hundreds of inter-linked networks (e.g., network clouds 120, 130 and 140).

Network clouds 120, 130 and 140 are built for targeted groups. The targeted group may be allocated according to various interest groups. In one embodiment, the targeted group includes lifestyle network, art and culture network, music network, sports network, pets network, fashion and beauty network, competition network and entertainment network. The user (using user device 160) may also be able to interact with other users from different targeted group. Hence, network system 100 may be able to provide a wide spectrum of users.

As shown in the embodiment of FIG. 1, network clouds 120, 130 or 140 are interlinked. Therefore, a user may choose to enter a particular network cloud 120, 130 or 140 and subsequently enter another network cloud 120, 130 or 140 without going through master social network 110. The flexibility provides a user to hop on to different network clouds 120, 130 or 140 with a click of a button. Furthermore, interlinked network clouds 120, 130 and 140 may be utilized to gather behavior pattern of the user within the respected network cloud 120, 130 or 140. This may subsequently allow social networking system 100 to provide specific information (e.g., advertisement, etc.) to the user.

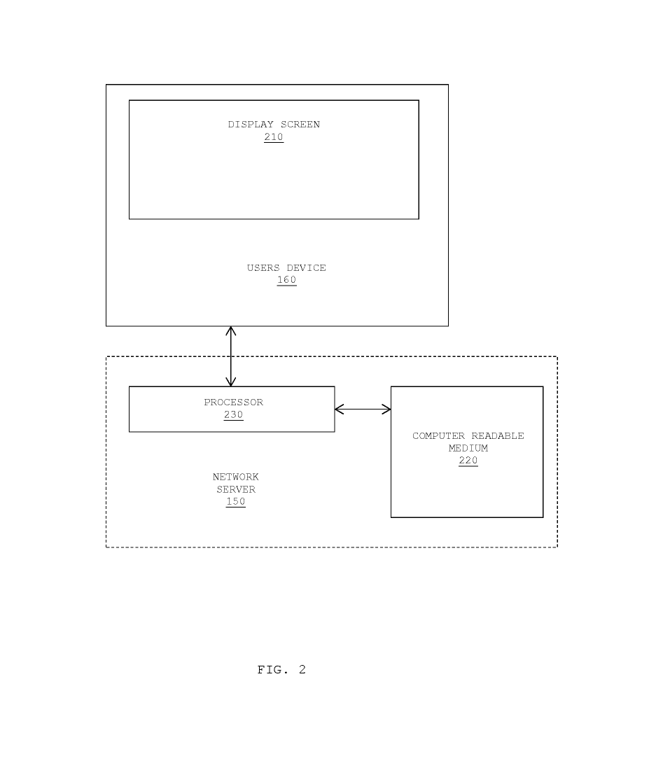

FIG. 2, meant to be illustrative and not limiting, illustrates interaction between network server and a user device in accordance with one embodiment of the present invention. In one embodiment, user device 160 and network server 150 may be similar to user device 160 and network server 150 of FIG. 1, respectively. User device 160 transmits a signal to processor 230 within network server 150. Processor 230 having a computer program within computer readable medium 220, processes the signal and transmits back a response signal to user device 160. The response then is processes by user device 160 and displayed on display screen 210. In one embodiment, display screen may display a webpage of the social networking system.

Still referring to FIG. 2, computer readable medium 220 includes any device that provides (i.e. stores and or transmits) information in a form readable by a computer, that when executed by the computer, can perform the functions executed by computer program. For example, computer readable medium 220 may include read only memory (ROM); random access memory (RAM); magnetic disk storage media; optical storage media; flash memory devices . Several embodiments of the present invention can comprise more than one computer readable medium depending on the design of the machine.

It should be appreciated that computer-executable instructions may include program modules that may be executed by a personal computer or a server. Generally, program modules include routines, programs, objects, components, data structures, etc., that perform particular tasks or implement particular abstract data types. Typically, the functionality of the program modules may be combined or distributed as desired in various environments.

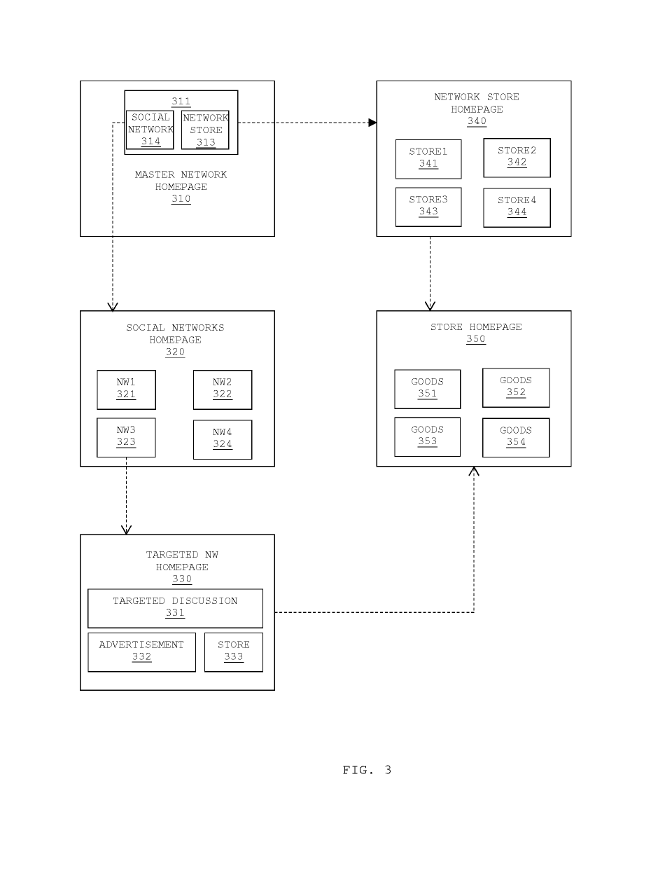

FIG. 3, meant to be illustrative and not limiting, illustrates webpages displayed on a user device when a user selects a particular button in accordance with one embodiment of the present invention. Master network homepage 310 is displayed immediately after a user enters a social networking system (e.g., social networking system 100 of FIG. 1). The user is within a master social network (e.g., master social network 110 of FIG. 1). Master network homepage 310 is displayed on a monitor screen of the user device (e.g., display screen 210 of FIG. 2). Information with regards to graphical user interface (GUI) for master network homepage 310 may be retrieved from a computer-readable medium (e.g., computer-readable medium 220 of FIG. 2).

Master network homepage 310 may include navigation bar 311. As shown in the embodiment of FIG. 3, navigation bar 311 includes two buttons, i.e., network store button 313 and social network button 314. Network store button 313 provides the user an access to network store homepage 340. Alternatively, social network button 314 provides the user an access to social network homepage 320.

In one embodiment, when the user selects social network button 314, social network homepage 320 may be displayed on the display screen. Social networks homepage 320 may include multiple targeted social network buttons 321-324. Targeted social network buttons 321-324 may include lifestyle network button, art and culture network button, music network button, sports network button, pets network button, fashion and beauty network button, competition network button and entertainment network button. Targeted social network button 321-324 may provide an access to the user to respective targeted network homepages (e.g., targeted network homepage 330). For example, a respective targeted social network buttons 321-324 that is a lifestyle network button may lead to lifestyle network homepage.

Targeted network homepage 330 is displayed on the display screen of the user when one of targeted social network buttons 321-324 is selected. At this point of time, the user has entered one of the network clouds (e.g., network clouds 120, 130 or 140) that are interlinked with master social network. In the embodiment of FIG. 3, targeted social network homepage 330 may include targeted discussion box 331, advertisement box 332 and store box 333. Targeted discussion box 331 and store box 333 may depend on the network cloud which the user has entered. For example, when the user enters sports network, targeted discussion box 331 may be include discussions of sports and store box 333 may be includes stores related to sports.

Advertisement box 332, on the other hand, may depend on the transactions of the user within the targeted social network and other targeted social networks that the user. It should be appreciated that each of the transaction by the user within targeted social networks may be marked to understand the pattern of the user. For example, if the user is a sport fan and is marked to access the sports network frequently and has on previous transactions purchased sports equipment, the user may be shown sports advertisement when entering a different targeted social network (e.g., lifestyle network).

In one embodiment, different advertisement box 332 may show one advertisement or multiple advertisements. The multiple advertisements may be shown simultaneously or at different instance of time. Therefore, still with regard to example of the user being the sport fan, when the user enters different targeted social network (e.g., lifestyle network), advertisement box 332 may show lifestyle-related advertisement and also sports-related advertisement.

Alternatively, when the user selects network store button 313 at master network homepage 310, network store homepage 340 may be displayed on the display screen. Networks store homepage 340 may include multiple store homepages 341-344. In one embodiment, store homepages may be related to lifestyle, art and culture, music, sports, pets, fashion and beauty, competition and entertainment.

When the user selects one of store homepage 341-344, the user will be linked to an internal webpage (internal to social networking system 100 of FIG. 1) that corresponds to a store network. Simultaneously, store homepage 350 will be displayed on the display screen. Store homepage 350 may include a plurality of goods 351-354. In addition to that, store homepage 350 may include platform for a user to purchase goods 351-354.

One of store homepages 341-344 may also be selected through store box 333 within targeted network homepage 330. When a user selects a store within store box 333, the user will be linked to the store network.

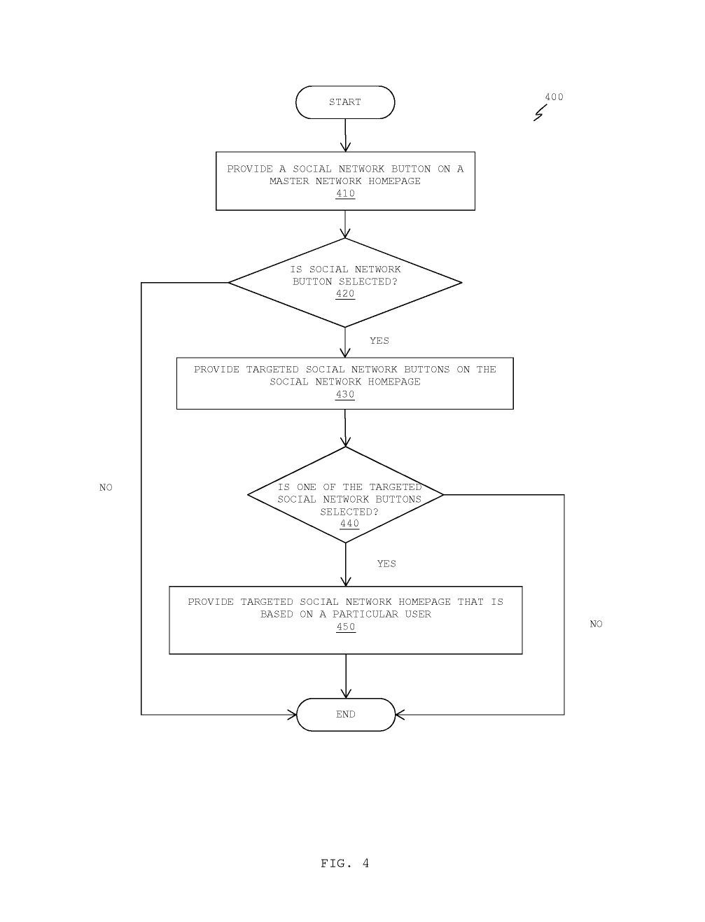

FIG. 4, meant to be illustrative and not limiting, illustrates a method of navigating social networking system in accordance with one embodiment of the present invention. Social networking system may be similar to social networking system 100 of FIG. 1. The method may be performed by a user using a user device (e.g., user device 160) in correspondence with a network server (e.g., network server 150 of FIG. 1), which is coupled to a master social network (e.g., master social network 110 of FIG. 1). At step 410, a social network button is displayed on master network homepage. The information with regards to the master network homepage and the social network button may be transmitted from the network server to the user device. Once the information is received by the user device, the information is displayed on the users device display screen (e.g., display screen 210 of FIG. 2). In one embodiment, the social network button and the master network homepage may be similar to social network button 314 and master network homepage 310 of FIG. 3. At step 420, the user may determine whether to select the social network button. If the user selects the social network button, the method proceeds to step 430. If the user does not select the social network button, the method is terminated.

At step 430, the user device may display to the user multiple targeted social network buttons on the social network homepage. The multiple targeted social network buttons may be similar to targeted social network buttons 321-324 of FIG. 3. At step 440, the user may determine whether to select one of the targeted social network buttons. If the user selects one of the targeted social network buttons, the method proceeds to step 450. If the user does not select one of the targeted social network buttons, the method is terminated. At step 450, a targeted social network homepage is displayed. The targeted social network homepage may be similar to targeted social network homepage 330 of FIG. 3 within the targeted social network.

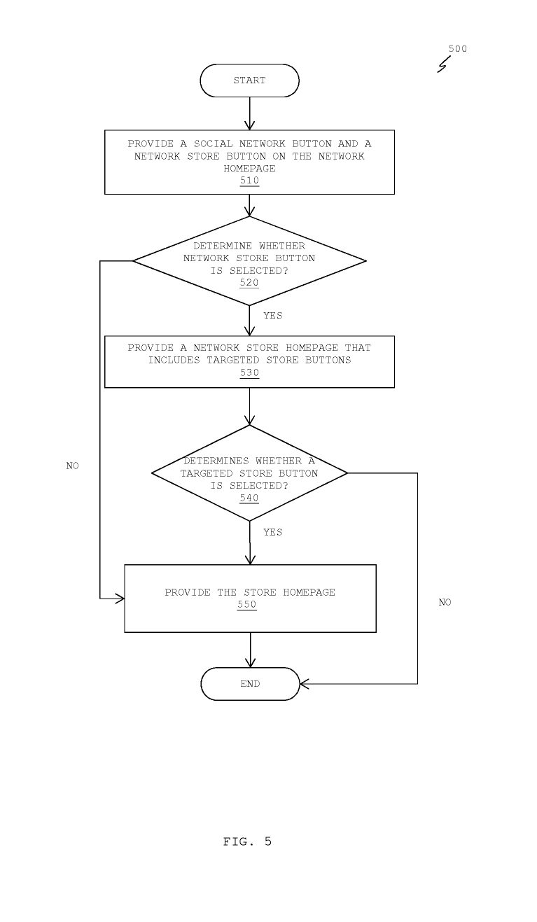

FIG. 5, meant to be illustrative and not limiting, illustrates another method of navigating social networking system in accordance with one embodiment of the present invention. Similar to method described in FIG. 4, method 500 may be utilized for navigating through social networking system 100 of FIG. 1. At step 510, a social network button and a network store button is displayed on a master network homepage. In one embodiment, the social network button and the store network button may be similar to social network button 314 and store network button 313 of FIG. 3. At step 520, the user may determine whether to select the network store button. If the user selects the network store button, the method proceeds to step 530. If the user does not select the social network button, method 500 is terminated.

At step 530, the user device displays to the user multiple targeted store buttons on a network store homepage. The network store homepage may be similar to network store homepage 340. Correspondingly, the multiple targeted store buttons may be similar to store buttons 341-344 of FIG. 3. At step 540, the user determines whether to select one of the targeted store buttons. If the user selects one of the targeted store buttons, the method proceeds to step 550. If the user does not select one of the targeted social network buttons, the method is terminated.

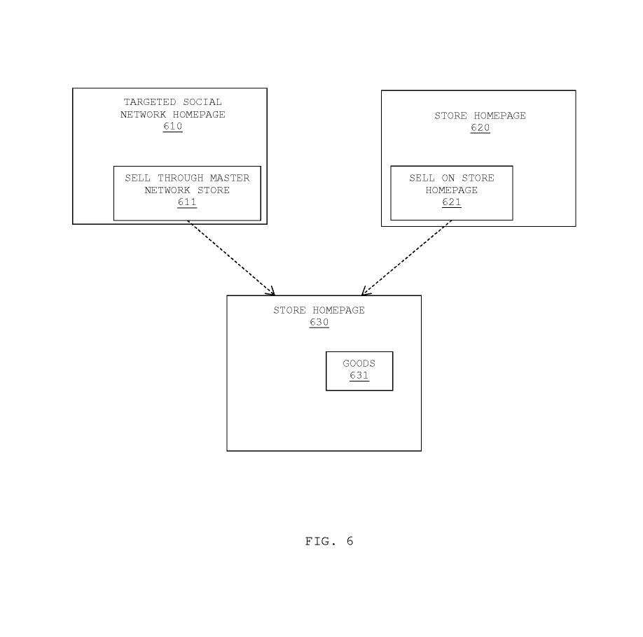

FIG. 6, meant to be illustrative and not limiting, illustrates an e-commerce business model that is available through the social networking system in accordance with one embodiment of the present invention. The social networking system may be similar to social networking system 100 of FIG. 1. In one embodiment, the e-commerce business model provides a capability to sell a product through targeted social network homepage 610. The capability to sell may be performed using sell through master network store button 611. When the sell through master network store button 611 is selected, the goods are placed on store homepage 630. The goods may be shown on store homepage 630 as goods 631. In one embodiment, the store homepage 630 that may include the goods may depend on the targeted social network that the user is in and the targeted social network that the user has previously used. It should be appreciated that the placement of the goods on store homepage 630 using the targeted social network homepage 610 may be similar to the placement of goods through store homepage 620, which is also by clicking on sell store homepage button 621.

Although the methods of operations were described in a specific order, it should be understood that other operations may be performed in between described operations, described operations may be adjusted so that they occur at slightly different times or described operations may be distributed in a system which allows occurrence of the processing operations at various intervals associated with the processing, as long as the processing of the overlay operations are performed in a desired way.

Although the foregoing invention has been described in some detail for the purposes of clarity, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. An electronic platform system for a targeted social network that is coupled to a data mining engine, comprising:
a store platform that displays selected electronic stores from a plurality of electronic stores, wherein the selected electronic stores are selected by the data mining engine according to the user and a user group of the user; and
a payment platform that enables the user to purchase goods directly from the store platform.

2. The electronic platform system as defined in claim 1, wherein the data mining engine selects the selected electronic stores by taking into account an age of the user, a location of the user and an interest of the user.

3. The electronic platform system as defined in claim 1, wherein the targeted social network is selected from a group of networks that consist of: a lifestyle network, an art and culture network, a music network, a sports network, a pets network, a fashion and beauty network, a competition network and an entertainment network.

4. The electronic platform system as defined in claim 1, wherein the selected electronic stores on a geographical location is different than the selected electronic stores on a different geographical location.

5. The electronic platform system as defined in claim 1, further comprising an advertisement engine, wherein the advertisement engine and the data mining engine provides selected advertisements from a plurality of advertisements to be displayed on the store platform.

6. The electronic platform system as defined in claim 1, wherein the payment platform is an electronic payment platform which allows the user to pay payment electronically.

7. A method for providing an electronic platform system of a targeted social network that is specific to a user and to a user group, comprising:
providing a store platform that displays a plurality of electronic stores that are targeted to the user according to their user group; and
providing a payment platform that enables the user to purchase goods directly from the store platform.

8. The method as defined in claim 7, wherein the targeted social network is selected from any one of an age-specific network, a location-specific network and an interest-specific network.

9. The method as defined in claim 8, wherein the targeted social network is selected from a group of networks, wherein the group of networks comprises any of a lifestyle network, an art and culture network, a music network, a sports network, a pet network, a fashion and beauty network, a competition network and an entertainment network.

10. The method as defined in claim 7, wherein the plurality of stores are displayed according to a geographical location of the user.

11. The method as defined in claim 7, wherein the user purchases the goods displayed using an electronic payment method provided by the payment platform.

12. The method as defined in claim 7, further comprising:
providing an advertisement platform that display a plurality of advertisements based on targeted social network.

13. The method as defined in claim 12, wherein the advertisement platform displays an advertisement according to activities of the user within the targeted social network and other targeted social networks to which the user has previously selected.

14. A computer system to provide an electronic platform system of a targeted social network that is specific to a user and to a user group, comprising:
a processor;
a memory connected to the processor; and
a computer readable medium having computer program code embedded therein, the computer program code configured to cause the processor to perform the operations of:
providing a store platform that displays a plurality of electronic stores that are targeted to the user according to their user group; and
providing a payment platform that enables the user to purchase goods directly from the store platform.

15. The computer system as defined in claim 14, wherein the computer program code further configures to cause the processor to perform the operation of:
displaying the plurality of electronic stores according to activities of the user within the targeted social network and other targeted social networks to which the user has previously selected.

16. The computer system as defined in claim 14, wherein the computer program code further configures to cause the processor to perform the operation of:
providing an advertisement platform that display a plurality of advertisements based on targeted social network.

17. The computer system as defined in claim 14, wherein the computer program code further configures to cause the processor to perform the operation of:
displaying the advertisement according to activities of the user within the targeted social network and other targeted social networks to which the user has previously selected.
